(19) United States
(12) Patent Application Publication
(10) Pub. No.: US 2013/0042170 A1
(43) Pub. Date: Feb. 14, 2013

(54) METHOD OF DRAFTING A CLAIM SET

(71) Applicant: Mr. Harold W. Milton JR., Bloomfield Hills, MI (US)

(72) Inventors: Harold W. Milton, JR., Bloomfield Hills, MI (US); Jacob Allen, Columbiaville, MI (US)

(73) Assignee: Mr. Harold W. Milton, JR., Bloomfield Hills, MI (US)

(21) Appl. No.: 13/652,994

(22) Filed: Oct. 16, 2012

Related U.S. Application Data
(63) Continuation-in-part of application No. 12/060,920, filed on Apr. 2, 2008.

(51) Int. Cl. G06F 17/21

(52) U.S. Cl. 715/225

(57) ABSTRACT

A method for drafting a claim set in a patent application presents a Tool bar including an Add Claim option. A picture claim is presented including a plurality of first claim recitations and a plurality second claim recitations divided by a characterized clause. By selecting the Add Claim option, a numbered claim set is presented including a broad claim and a first and second set of dependent claims. The second claim recitations are automatically presented in the first set of sequentially numbered dependent claims. The first claim recitations are automatically presented in the second set of sequentially numbered dependent claims following the first set of dependent claims. At least one user defined novel limitation is selected and placed after the characterized by clause in the broad claim and user defined supportive limitations are selected and placed before the characterized by clause.

### CROSS REFERENCE TO RELATED APPLICATION

This subject application is a continuation-in-part of U.S. patent application Ser. No. 12/060,920 filed Apr. 2, 2008, which claims priority to U.S. Provisional Application No. 60/846,326 filed Sep. 21, 2006, and is related to U.S. patent application Ser. No. 09/273,021 filed Mar. 19, 1999, now U.S. Pat. No. 7,890,851 granted Feb. 15, 2011, and 11/300,207 filed Dec. 14, 2005.

### BACKGROUND OF THE INVENTION

1. Field of the Invention

The present invention relates to a method of preparing a patent application including drafting a claim set in conjunction with a word processing program.

2. Description of the Prior Art

A method of preparing a patent application is disclosed in U.S. Pat. No. 7,890,851, in the name of one of the inventors herein. That method includes the steps of numbering and rearranging the order of claims and duplicating claims into the specification and assigning reference numerals to elements. Further, a method of preparing a patent application is disclosed in U.S. patent application Ser. No. 11/300,207, filed Dec. 14, 2005. That method discloses the step of, running a software macro to present a tool bar in a word processing program. An option is presented in the Tool bar on a display screen of Add Claim. A numbered claim is presented in the patent application in response to selecting Add Claim. This invention is in further perfection of the steps set forth in the aforementioned methods.

### SUMMARY OF THE INVENTION AND ADVANTAGES

The invention provides a method for preparing a patent application and adds to the prior mentioned program. The Add Claim option located on the Tool bar presents an independent claim including a characterized by clause. A plurality of first claim recitations are selected by the user in a first sequential order and are inserted in the independent claim prior to the characterized by clause with each of the first claim recitations being appropriate for designating a recitation that is known in the prior art. A plurality of second claim recitations are selected by the user in a second sequential order and are inserted in the independent claim following the characterized by clause with each of the second claim recitations designating a recitation absent in the prior art. The Add Claim option is again selected. In response, a numbered claim set is presented including a broad claim and a first and second set of dependent claims. The first set of dependent claims precedes the second set of dependent claims. Each claim of the first set of dependent claims recites a different one of the second claim recitations with the first set of dependent claims following the second sequential order of the second claim recitations. Each claim of the second set of dependent claims recites a different one of the first claim recitations with the second set of dependent claims following the first sequentially order of the first claim recitations. Advantageously, this method generates a claim set where dependent claims reciting novel recitations not found in the prior art precede those dependent claims reciting recitations describing that which is known in the prior art.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a Tool bar utilized during the method of the subject invention;

FIG. 2 is a schematic view of an Add Claim option Block utilized during the method of the subject invention;

FIG. 3 is a schematic view of a Preamble text block utilized during the method of the subject invention;

FIG. 4 is a schematic view of the form text of an exemplary detailed claim generated in accordance with the method of the subject invention;

FIG. 5 is a schematic view of the modified text of the exemplary detailed claim generated in accordance with the method of the subject invention;

FIG. 6 is a schematic view of the form text of an exemplary broad claim generated in accordance with the method of the subject invention;

FIG. 7 is a schematic view of an exemplary claim set generated in accordance with the method of the subject invention; and

FIG. 8 is a schematic view of the exemplary claim set after it has been modified in accordance with the method of the subject invention.

### DETAILED DESCRIPTION OF THE INVENTION

Referring to the Figures, wherein like numerals indicate corresponding parts throughout the several views, a method and apparatus of drafting a claim set in preparing a patent application using a computer program is illustrated by showing the various steps in the form of computer screen displays.

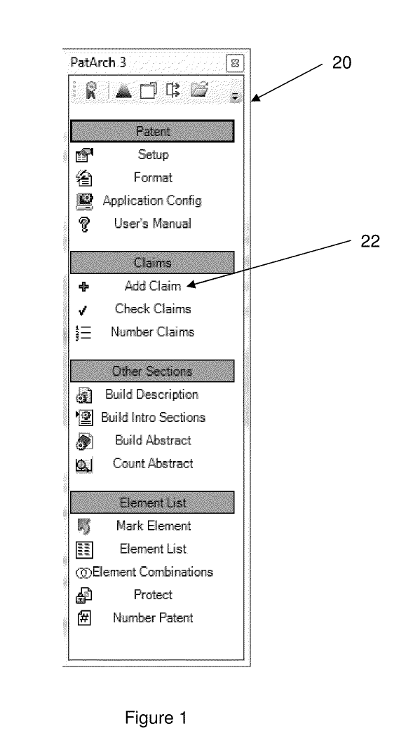

The method described is performed in conjunction with a word processing program. The program, by running a software macro, to presents a Tool bar 20 in or over a word processing program to facilitate in the drafting of a claim set for a patent application. The Tool bar 20 is illustrated in FIG. 1. Although this application describes a method for preparing a claim set, the program and its Tool bar 20 also facilitate other functions such as checking claims, checking for claim errors, numbering claims, building the description, building the introduction sections, building the abstract, counting the abstract, marking elements preparing an element list, numbering the patent, and several other functions that aid in patent drafting. These functions are covered and described in U.S. patent application Ser. No. 09/273,021, filed Mar. 19, 1999, now U.S. Pat. No. 7,890,851 granted Feb. 15, 2011, and 11/300,207, filed Dec. 14, 2005.

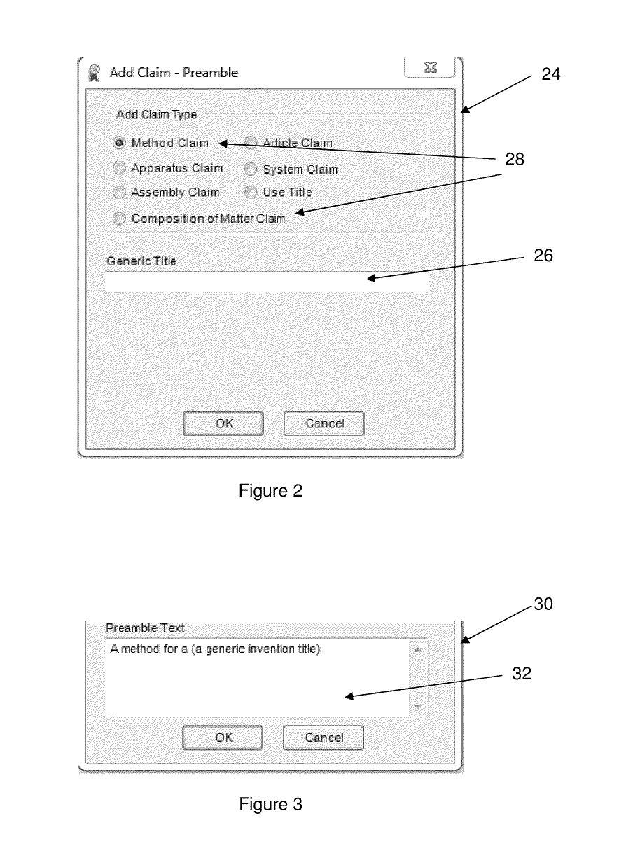

Referring to FIG. 1, the method begins by presenting options in the Tool bar 20 on a display screen. The first step includes selecting the Add Claim option 22 in the Tool bar 20 to present a next numbered claim. This claim is a detailed numbered claim, or picture claim (a word picture), including a characterized by clause and all elements of the invention. In response to selecting the Add Claim option 22, an Add Claim option block 24 is presented having a Generic Title text block 26 for including the title of the patent application and a plurality of class options 28 including a method claim option and an apparatus claim option and an article claim option and a composition of matter claim option as illustrated in FIG. 2.

Referring to FIG. 3, a Preamble Data box 30 is displayed in response to selecting OK in the Add Claim option block 24. The Preamble Data box 30 displays the partial text of the detailed numbered claim's preamble. For instance, the text “A method for” is displayed in the Preamble Text block 32 in response to selecting the method claim option in the Add Claim option block 24. The text “An apparatus for” is displayed in the Preamble Text block 32 in response to selecting the apparatus claim option in the Add Claim option block 24. The text “An article for” is displayed in the Preamble Text block 32 in response to selecting the article claim option in the Add Claim option block 24. The text “A composition of matter comprising” is displayed in the Preamble Text block 32 in response to selecting the composition of matter claim option in the Add Claim option block 24.

The respective text in the Preamble Text block 32 is then inserted into the picture claim 34 in response to selecting OK. Following the preamble, a form text is also displayed reading:

“comprising,

(word picture of the prior art),
and characterized by,
(word picture of the novelty).”

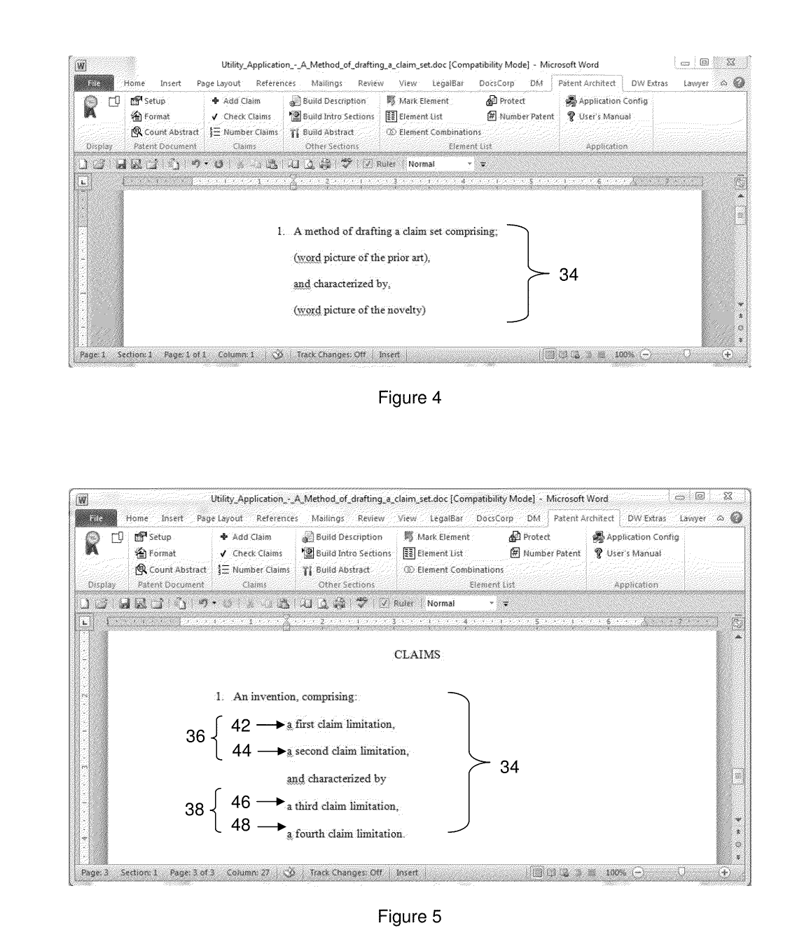

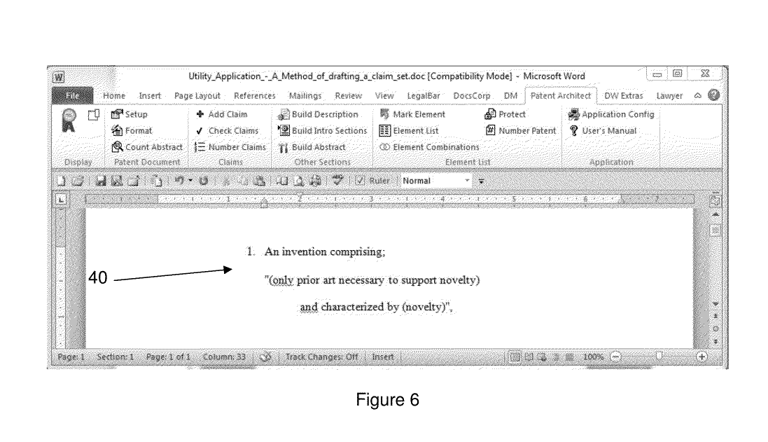

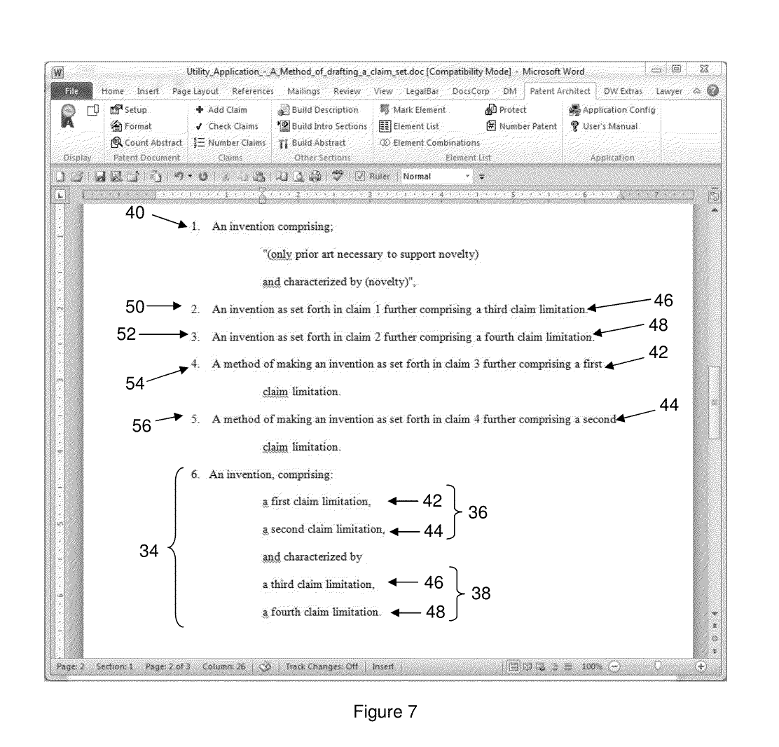

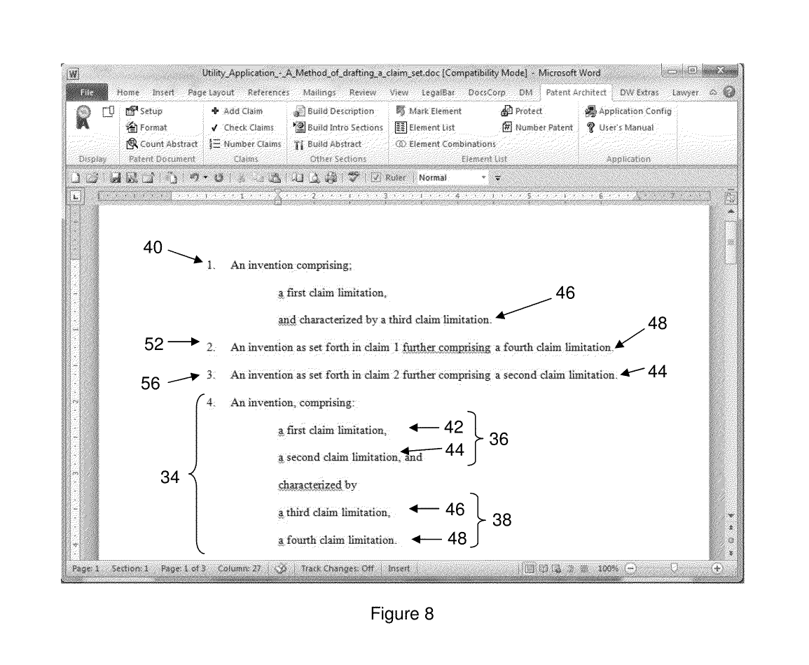

For instance, if the method claim option is selected, then the picture claim 34 would include the text illustrated below and in FIG. 4:

“A method comprising,

(word picture of the prior art),
and characterized by,
(word picture of the novelty)”.

In general, a user drafts and inserts a plurality of first claim recitations 36 into the picture claim 34 in a first sequential order between the preamble and characterized by clause. As shown in FIG. 5, each of the first claim recitations 36 describes an old element that is found in the prior art. The user also drafts and inserts a plurality of second claim recitations 38 into the picture claim 34 in a second sequential order after the characterized by clause. Each of the second claim recitations 38 describes a novel element of the invention that is absent in the prior art. The determination of novelty with respect to the claim recitations 36, 38 is made by the user.

In response to selecting the Add Claim option 22 in the Tool bar 20, a second time, a numbered claim set is automatically presented and expedites the user's drafting of a broad claim 40 and a plurality of dependent claims 50, 52, 54, 56. A broad claim, or first independent claim 40, is automatically presented in the claim set and includes the preamble and characterized by clause of the picture claim 34. Each of the second claim recitations 38 (the novel recitations) is automatically presented in a separate sequentially numbered dependent claim 50, 52 following the first independent claim 40 in the claim set. These claims comprise the first set of dependent claims 50, 52 and follow the second sequential order of the second claim recitations 38. Each of the first claim recitations 36 (the old recitations) is automatically presented in a separate sequentially numbered dependent claim 54, 56. These claims comprise the second set of dependent claims 54, 56 which follow the first set of dependent claims 50, 52 in the claim set. It should also be appreciated that the second set of dependent claims 54, 56 follow the first sequential order of the first claim recitations 36.

The user selects at least one of the first claim recitations 50, 52 designating it as a user defined novel limitation of the invention. In response, the user defined novel limitation is placed in the first dependent claim 40 after the characterized by clause. The user also selects at least one limitation from the second set of dependent claims 54, 56 designating it as a user defined supportive limitation. The user selects user defined supportive limitations by choosing old elements that are necessary to support the user defined novel limitation. In response, the user defined supportive limitations are placed in the first independent claim 40 between the preamble and the characterized by clause.

In a specific example of the invention, the first claim recitations 36 are drafted in the picture claim 34 in a first sequential order between the preamble and the characterized by clause. The first claim recitations 36 include at least a first claim limitation 42 and a second claim limitation 44 each being user defined and describing an old element that is found in the present invention and the prior art. Meaning, if an element of the present invention is found in the prior art, this element is old and should be placed before the characterized by clause in the picture claim 34. The second claim recitations 38 are drafted in the picture claim 34 in a second sequential order after the characterized by a clause. The second claim recitations 38 include at least a third claim limitation 46 and a fourth claim limitation 48 each being user defined and describing a novel element that is found in the present invention but is absent from the prior art (unknown in the art).

The first and second claim limitations 42, 44 (the old limitations) are substituted for “(word picture of the prior art)” in the picture claim 34. The third and fourth claim limitations 46, 48 (the novel limitations) are substituted for the text, “(word picture of the novelty)” in the picture claim 34.

The text structure should be similar to the follow:

CLAIMS

1. An invention, comprising:

a first claim limitation,
a second claim limitation,
characterized by
a third claim limitation, and
a fourth claim limitation.

In response to selecting Add Claim in the Tool bar 20, a second time, a claim set is presented beginning with a first independent claim 40 including the preamble of the picture claim 34 and the text:

“(only prior art necessary to support novelty)

and characterized by (novelty)”,

A first dependent claim 50 is presented on the display screen including the phrase “An invention as set forth in claim 1 further comprising” followed by the third claim limitation 46. A second dependent claim 52 is presented on the display screen including the phrase “An invention as set forth in claim 2 further comprising” followed by the fourth claim limitation 48. A third dependent claim 54 is presented on the display screen including the phrase “An invention as set forth in claim 3 further comprising” followed by the first claim limitation 42. A fourth dependent claim 56 is presented including the phrase “An invention as set forth in claim 4 further comprising” followed by the second claim limitation 44. The picture claim 34 is placed at the end of the claim set after the fourth dependent claim 56.

For instance, the claim set presented on the display screen of the computer would include the text:

1. An invention, comprising:

“(only prior art necessary to support novelty)
and characterized by (novelty)”,

2. An invention as set forth in claim 1 further comprising a third claim
limitation.
3. An invention as set forth in claim 2 further comprising a fourth claim
limitation.
4. A method of making an invention as set forth in claim 3 further
comprising a first claim limitation.
5. A method of making an invention as set forth in claim 4 further
comprising a second claim limitation.
6. An invention, comprising:

a first claim limitation,
a second claim limitation,
characterized by
a third claim limitation, and
a fourth claim limitation.

The user selects at least one claim limitation from the first set of dependent claims 50, 52 designating it a user defined novel limitation. The user defined novel limitation is then substituted for “(novelty)” in the first independent claim 40. The user also selects at least one claim limitation from the second set of dependent claims 54, 56 designating it a user defined supportive limitation. For example, the third claim limitation 46 may be selected as the user defined novel limitation. The first claim limitation 42 may be selected as necessary to support the structure of the third limitation 46 and is then substituted “(prior art)” in the first independent claim 40.

Finally, dependent claims repeating claim limitations recited in the first independent claim 40 are deleted from the claim set. In this example, the first dependent claim 50 (claim 2) and the third dependent claim 54 (claim 4) repeat claim limitations recited in the first independent claim 40 (claim 1) and will be deleted from the claim set.

For instance, the claim set would now include the text:

1. An invention, comprising:

first claim limitation,
and characterized by
third claim limitation.

2. An invention as set forth in claim 2 further comprising a fourth claim
limitation.
3. An invention as set forth in claim 3 further comprising a second claim
limitation.
4. An invention, comprising:

a first claim limitation,
a second claim limitation,
characterized by
a third claim limitation, and
a fourth claim limitation.

Obviously, many modifications and variations of the present invention are possible in light of the above teachings and may be practiced otherwise than as specifically described while within the scope of the appended claims. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A method of drafting a claim set in preparing a patent application using a computer program comprising the steps of;
running a software macro in a word processing program to present a Tool bar having an Add claim option,
presenting in the word processing program a format for a picture claim including a preamble and a characterized by clause,
selecting by the user in a first sequential order a plurality of first claim recitations,
inserting the first claim recitations into the picture claim between the preamble and the characterized by clause in the first sequential order to designate the first claim recitations as appropriate for describing the prior art,
selecting by the user in a second sequential order a plurality of second claim recitations,
inserting the second claim recitations into the picture claim after the characterized by clause in the second sequential order to designate the second claim recitations as being absent in the prior art,
selecting Add claim in the Tool bar,
presenting in the word processing program a first independent claim reciting the preamble and characterized by clause of the picture claim in response to selecting Add claim in the Tool bar,
presenting in the word processing program a first set of sequentially numbered dependent claims after the first independent claim with each claim of the first set of claims reciting a different one of the second claim recitations and following the second sequential order of the second claim recitations,
presenting in the word processing program a second set of sequentially numbered dependent claims after the first set dependent claims with each claim of the second set of claims reciting a different one of the first claim recitations and following the first sequential order of the first claim recitations,
selecting at least one claim recitation from the first set of dependent claims as a user defined novel limitation of the invention, and
placing the user defined novel limitation in the first independent claim after the characterized by clause.

2. A method as set forth in claim 1 including selecting at least one claim recitation from the second set of dependent claims as a user defined supportive limitation to correspond with the user defined novel limitation and placing the user defined supportive limitation in the first independent claim between the preamble and the characterized by clause.

3. A method as set forth in claim 2 including presenting the first independent claim in the word processing program with the text:
“(only prior art necessary to support novelty)
and characterized by (novelty)”
and replacing the “(novelty)” portion of the text with the at least one user defined novel limitation and replacing the “(only prior art necessary to support novelty)” portion of the text with the at least one user defined supportive limitation.

4. A method of drafting a claim set in preparing a patent application using a computer program comprising the steps of,
running a software macro in a word processing program to present a Tool bar,
presenting an Add claim option in the Tool bar on a display screen,
presenting an Add claim option block having a Generic Title text block for including the title of the patent application and a Preamble Text Block and a plurality of claim options including a method claim option and an apparatus claim option and an article claim option and a composition of matter claim option,
displaying the text “A method for” and the application title in the Preamble Text block in response to selecting the method claim option in the Add claim option block,
displaying the text “An apparatus for” the application title in the Preamble Text block in response to selecting the apparatus claim option in the Add claim option block,
displaying the text “An article for” the application title in the Preamble Text block in response to selecting the article claim option in the Add claim option block,
displaying the text “A composition of matter comprising” the application title in the Preamble Text block in response to selecting the composition of matter claim option in the Add claim option block,
presenting an OK option in the Preamble Text block,
selecting the OK option in the Preamble Text block,
presenting a format for a picture claim in the word processing program in response to selecting OK in the Preamble Text block wherein the picture claim includes a preamble reciting the text in the Preamble Text block and the text
“comprising,
(word picture of the prior art),
and characterized by,
(word picture of the novelty)” following the preamble,
drafting by the user in a first sequential order a plurality of first claim recitations,
inserting the first claim recitations in the picture claim between the preamble and the “characterized by” portion of the text with the first claim recitations including at least a first claim limitation and a second claim limitation each being appropriate for describing the prior art,
replacing the “(word picture of the prior art)” portion of the text in the picture claim with the first claim recitations,
drafting by the user in a second sequential order a plurality of second claim recitations,
inserting the second claim recitations in the picture claim after the “characterized by” portion of the text with the second claim recitations including at least a third claim limitation and a forth claim limitation each being appropriate for describing a novel recitation found in the invention and absent in the prior art,
replacing the “(word picture of the novelty)” portion of the text of the picture claim with the second claim recitations,
selecting Add claim in the Tool bar,
running a software macro to generate and present on the display screen a claim set beginning with a first independent claim as claim 1 including the preamble of the picture claim and the text
“(only prior art necessary to support novelty)
and characterized by (novelty)” in response to selecting Add claim in the Tool bar,
running a software macro to generate and present on the display screen a first dependent claim including the phrase “An invention as set forth in claim 1 further comprising” followed by the third claim limitation of the picture claim in response to selecting Add claim in the Tool bar,
running a software macro to generate and present on the display screen a second dependent claim including the phrase “An invention as set forth in claim 2 further comprising” followed by the fourth claim limitation of the picture claim in response to selecting Add claim in the Tool bar,
running a software macro to generate and present on the display screen a third dependent claim including the phrase “An invention as set forth in claim 3 further comprising” followed by the first claim limitation of the picture claim in response to selecting Add claim in the Tool bar,
running a software macro to generate and present on the display screen a fourth dependent claim including the phrase “An invention as set forth in claim 4 further comprising” followed by the second claim limitation of the picture claim in response to selecting Add claim in the Tool bar,
running a software macro to place the picture claim at the end of the claim set and after the fourth dependent claim,
selecting at least one of the first claim recitations as a user defined novel limitation of the invention,
replacing the “(novelty)” portion of the text in the first independent claim with the user defined novel limitation,
selecting at least one of the second claim recitations as a user defined supportive limitation corresponding with the user defined novel limitation,
replacing the “(prior art)” portion of the text in the first independent claim with the user defined supportive limitation, and
deleting dependent claims from the claim set repeating a claim limitation recited in the first independent claim.
